(19) United States
(12) Patent Application Publication
(10) Pub. No.: US 2013/0136295 A1
(43) Pub. Date: May 30, 2013

(54) Loudspeaker Based on "The Principle of The Center Of Percussion."

(71) Applicants: Andrei Ilies, Lincolnwood, IL (US); Luminita Ilies, Lincolnwood, IL (US); Andrew N. Ilies, Lincolnwood, IL (US)

(72) Inventors: Andrei Ilies, Lincolnwood, IL (US); Luminita Ilies, Lincolnwood, IL (US); Andrew N. Ilies, Lincolnwood, IL (US)

(21) Appl. No.: 13/304,611

(22) Filed: Nov. 25, 2011

(51) Int. Cl. H04R 9/06

(52) U.S. Cl. 381/400

(57) ABSTRACT

A transducer of electrical oscillations to mechanical oscillations, mainly a loudspeaker having in general an elongated oscillating member attached by joints to a surrounding structure in areas of points or lines of specific dynamic balance, like one end, center of mass, center of percussion about a certain point or axis of rotation. At least one electromagnetic actuator is mounted in the area of these balancing points or lines. The use of the principle of the center of percussion is allowing for higher loudspeaker performance.

### BACKGROUND OF THE INVENTION

This invention relates to loudspeakers of dynamic type. In general any kind of electromechanical transducers that can reach outside the acoustic range are to be considered too.

The dynamic loudspeakers, having a voice coil placed in the gap of an electromagnet or permanent magnet are mainly of two categories. The first category is the cone type, flat type and the soft and hard domes. The second category is the planar speaker.

The main disadvantage of the first category is the predominant piston-like motion of the oscillating member resulting in an abrupt mechanical inertial saturation. Their membrane is also very thin compared to their other dimensions, being highly transparent to the sound, allowing for the sound in opposition of phase, produced on the rear side of the oscillating member to cancel part of the sound produced on the front side of the speaker, diminishing the efficiency of the transducer.

The dynamic transducers can be compared to a physical pendulum. After ceasing of the driving force these transducers will have their membranes bounce before they come to a still-stand, just like the pendulum would. This bouncing is especially obvious in frequency and amplitude transitions. Even with considerable dumping provisions, this phenomenon poses clear limitations on the transducer's performance. The bouncing takes place with a frequency of the value of the resonance frequency of the transducer itself. So, the transducer itself will introduce frequencies not present in reality in the message conveyed to it.

The planar loudspeakers have their oscillating members made in general of stiff, lower density material or an assembly of materials, having in general a noticeable thickness. This makes them overcome the setback of acoustic transparency of their membranes. Also, part of them favor the propagation of mechanical energy in form of transversal waves along and across their oscillating member. The efficiency of energy transfer is superior in this case because it happens with less dissipation due to inertial reaction of a relatively less concentrated mass of the oscillating member.

The disadvantage of a generally stiff and thick membrane is that it is not able to handle the propagation of transversal oscillations in two perpendicular directions without excessively stressing their body and introducing distortions over a permissible limit.

Certain designs of planar loudspeakers have adopted an elongated shape of the oscillating member, with noticeable advantages, but the unnecessary internal stressing of their poorly balanced membranes still bring about a high level of distortion.

There is an obvious need to improve the efficiency and accuracy of all acoustical transducers in particular and all of the electromechanical transducers in general. The present invention addresses these requirements.

### DESCRIPTION

### Brief Summary of the Invention

The present invention describes a loudspeaker having an oscillating member built in general of a relative thick, stiff, lower density body.

Due to its elongated shape, the oscillating member will favor the propagation of mechanical oscillations as transversal waves in the predominant direction of it, the longitudinal direction, while the oscillations in the direction of the width of the oscillating member are being kept minimal.

The sound is created by a whipping action of the oscillating member on the mass of air in the proximity of its surface.

To attain a high fidelity of reproduction, in the preferred embodiment of the invention, the oscillating member of the loudspeaker is attached to its surrounding supporting structure or base on a minimum number of pegs. These pegs can be considered as pivoting joints placed as multiples along one line across the width of the oscillating member or as singles in certain points of interest.

Given its elongated shape, relative stiffness, as well its relative high rate of vibration with small amplitude compared to its length, it is safe to presume that the oscillating member behaves like a solid stick. It is obvious that, in this case, the most dynamically stable state will be reached if the oscillating member would be forced to swing around at least one axis, which could be, like in the preferred embodiment of the invention, one end of the oscillating member, a line through the center of mass of the entire oscillating member, or any conveniently chosen point or line along the oscillating member.

By choosing, in the preferred embodiment of the invention, to have an oscillating member as a three dimensional elongated body with a so called first end and a so called second end, the oscillating member is supported by pivoting points or pivoting lines across respectively the first end and secondly a location across the body different from the second end of the body. The voice coil is placed between the two pivoting points or lines in such a way that the second pivoting point or pivoting line finds itself in the center of percussion of part of the oscillating member between the voice coil and the second end of the oscillating member about the point or line through the center of the voice coil. “Center of Percussion” is defined in the Webster Encyclopedia as: “The point on a rigid body, suspended so as to be able to move freely about a fixed axis, at which the body may be struck without changing the position of the axis.”

In an alternative to the preferred embodiment of the invention the pivoting point or line along the first end of the oscillating member is moved away from the first end of the oscillating member in a position to create according to the principle of the center of percussion the optimum dynamic balance of the oscillating member.

The result is an unprecedented quality, efficiency and throughput of the transducer as presented in the preferred embodiment of the invention and further accomplished by drawings that illustrate the principle of the invention.

### BRIEF DESCRIPTION OF DRAWINGS

The various advantages and features of the invention will be further brought forward by the following discussion taken in conjunction with the set of drawings in which:

FIG. 1a is a rear view of the electromechanical transducer, in particular a loudspeaker as the preferred embodiment of the invention.

FIG. 1b is a left view of FIG. 1a.

FIG. 1c is a right view of FIG. 1a.

FIG. 2 is a simplified representation showing a cross section side view of the loudspeaker as the preferred embodiment of the invention.

FIG. 3 is a simplified representation showing a cross section side view of the loudspeaker as an alternative to the preferred embodiment of the invention.

### DETAILED DESCRIPTION OF THE INVENTION

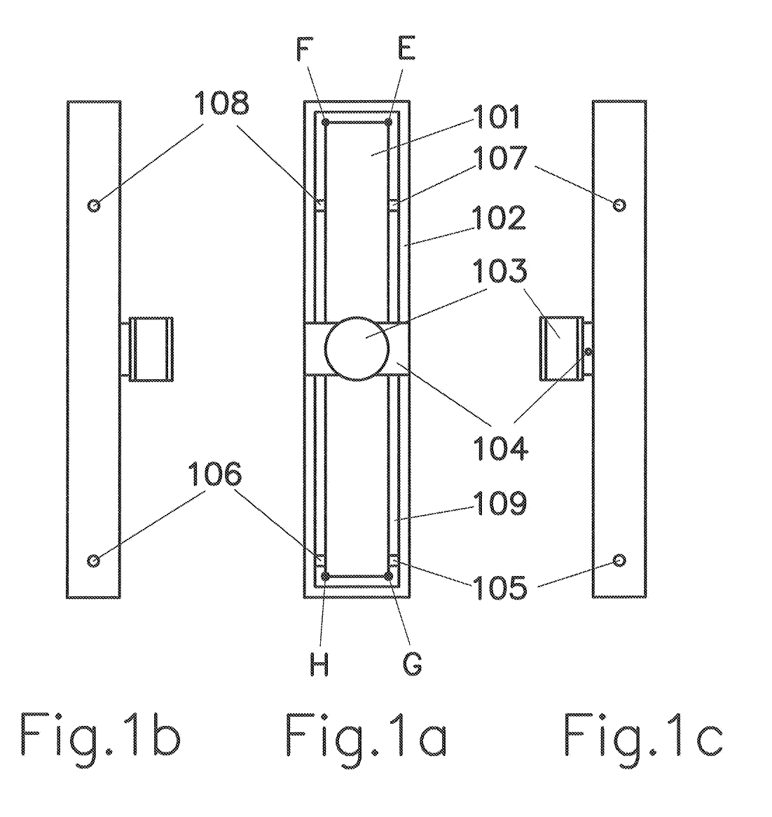

FIG. 1a is showing the rear view of an actual loudspeaker in which the oscillating member (101) is attached to the rigid mounting structure plate or frame (102) by means of two pairs of joints, (105)-(106) and (107)-(108). In all the rest of its surrounding the oscillating member is separated from the solid frame through the air gap (109). The voice coil of the magnetic assembly (103) is attached to the oscillating member (101) in between the pivoting line (105)-(106) and the pivoting line (107)-(108). The magnet of the magnetic assembly (103) is mounted on the bridge (104), which is mounted onto the mounting structure (102). The first end GH of the oscillating member is suspended between the pair (105)-(106) of joints. The second pair, (107)-(108) of joints is attached to the oscillating member (101) along the line of the center of percussion of the part of the oscillating member between the center of the voice coil of the magnetic assembly (103) attached onto the oscillating member (101) and the second end EF of the oscillating member, about the point of the center of the voice coil, part of the magnet assembly. In this case, according to the principle of “The Center of Percussion”, the center of the voice coil will move free of any mechanical reaction from the oscillating member (101), which brings about the fact that the entire oscillating member in its instantaneous translation movement induced by the voice coil will tend not to move. From the dynamic point of view it seems like the entire oscillating member is “frozen” in place. The oscillating member (101) will act upon the pair of joints (105)-(106) and (107)-(108) in a very particular way, that is, for every one movement of the voice coil, there will be the same qualitative movement tendency in the opposite direction into the pair of joints (105)-(106) and also in the pair of joints (107)-(108). The mechanical reaction of the pair of joints (105)-(106) and (107)-(108) will act upon the oscillating member as two virtual voice coils in phase with the physical voice coil, improving the efficiency of the loudspeaker.

FIG. 1b is showing the joints (106) and (108).

FIG. 1c is showing the joints (105) and (107).

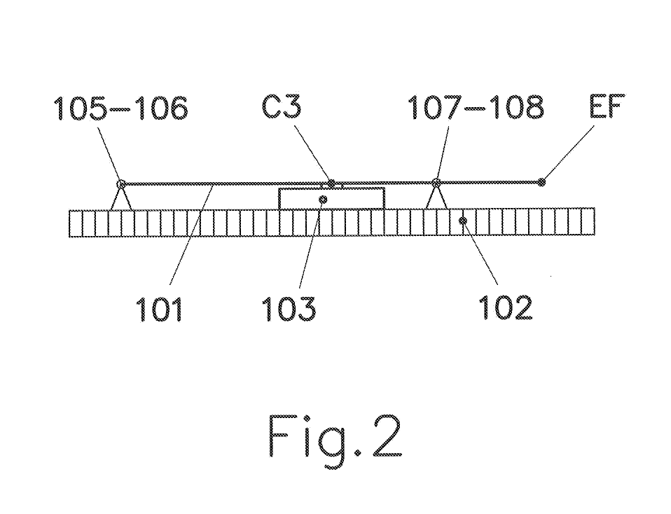

FIG. 2 is showing a simplified drawing of the preferred embodiment of the invention in which can be seen how the magnetic assembly (103) with its voice coil C3 is placed between the pivoting line (105)-(106) and pivoting line (107)-(108).The pivots (105),(106), (107), (108) and the magnet of the magnetic assembly (103) are all attached onto the mounting structure (102).The three lines across the width of the oscillating member (101) through C3, (107)-(108) and EF have to be placed such as the pivoting line (107)-(108) is the line through the center of percussion of the part of the oscillating member (101) between the line through the center of the voice coil C3 and the second end of the oscillating member EF about the center line of the voice coil C3.

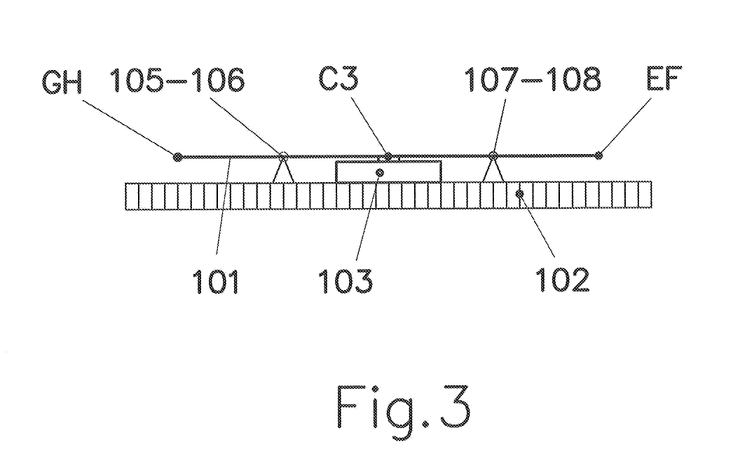

FIG. 3 is showing a simplified side view in cross section of a loudspeaker as an alternative to the preferred embodiment of the invention where the pivoting line (105)-(106) has been moved in a position as to be along the center of percussion of the part of the oscillating member (101) between the center of the voice coil C3 and the end GH about the line through the center of the voice coil, same as the condition fulfilled by the position of the pivoting line (107)-(108), as to find itself along the line through the center of percussion of the part of the oscillating member between the center of the voice coil C3 and the end EF about the line through the center of the voice coil. The pivots (105), (106), (107), (108) and the magnet of the magnetic assembly are attached to the mounting structure (102).

I claim as my invention

1. A transducer of electrical oscillations into mechanical oscillations, mainly a dynamic loudspeaker, comprising a magnet generating a permanent magnetic field around a voice coil, the voice coil being attached onto an oscillating body resting on at least two pegs or two lines of at least two pegs mounted together with the magnetic field generator on a rigid supporting structure having the pegs or lines of pegs placed such as to bring about a maximum of dynamic stability to the oscillating body by placing the elements of the loudspeaker along the oscillating body in positions as to fulfill the conditions of the principle of the center of percussion.

2. A loudspeaker as described in claim 1, having a first end of the oscillating body resting on a first peg or line of at least two pegs, the second peg or line of at least two pegs being placed such as to place the voice coil between the first peg or line of pegs and the second peg or line of pegs; the position of the second peg or line of pegs being along the center of percussion of part of the oscillating body between the centerline of the voice coil and the second end of the oscillating body about the centerline of the voice coil.

3. A loudspeaker as described in claim 1, having a first peg or line of at least two pegs between the centerline of the voice coil and a first end of its oscillating body and a second peg or line of at least two pegs between the centerline of the voice coil and the second end of its oscillating body; the first peg or line of at least two pegs is placed along the line of the center of percussion of the part of its oscillating body between the centerline of the voice coil and the first end of its oscillating body about the centerline of the voice coil; the second peg or line of at least two pegs is placed along the center of percussion of the part of its oscillating body between the centerline of the voice coil and the second end of its oscillating body about the centerline of the voice coil.
